(19) United States
(12) Patent Application Publication
(10) Pub. No.: US 2008/0261017 A1
(43) Pub. Date: Oct. 23, 2008

(54) Hollow Fiber Membrane and Preparing Method Thereof

(76) Inventors: Sung Su Bae, Gyeonggi-do (KR); Tae Jeong Kim, Gyeonggi-do (KR); Sang Hoon Kim, Gyeonggi-do (KR); Soon Hyuk Im, Seoul (KR); Hang Duk Rho, Gyeonggi-do (KR)

Correspondence Address: FROMMER LAWRENCE & HAUG, 745 FIFTH AVENUE- 10TH FL., NEW YORK, NY, 10151, US

(21) Appl. No.: 12/089,135

(22) PCT Filed: Oct. 9, 2006
(86) PCT No.: PCT/KR2006/004045

§ 371 Date: Apr. 3, 2008

(30) Foreign Application Priority Data
Mar. 16, 2006 (KR) 10-2006-0024494

(51) Int. Cl. C08K 5/06

(52) U.S. Cl. 428/315.5; 524/377; 264/114

(57) ABSTRACT

The present invention relates to a polyvinylidene difluoride hollow fiber membrane and a method of preparing the same, and more particularly, to an improved polyvinylidene difluoride hollow fiber membrane and a preparation method thereof, in which a spinning solution consisting of polyvinylidene fluoride, alcohol dendrimer and organic solvent is prepared, and then is subjected to solidification by a wet-phase transition process, cleaning and drying, in which alcohol dendrimer that is an organic material as a pore former is introduced, allowing uniform disperse of alcohol dendrimer in polyvinylidene difluoride to form pores, with each having a high dispersion ability and a uniform size, and in which an excellent adhesion durability is imparted, owing to the use of a single material of polyvinylidene difluoride, unlike the conventional hollow fiber membrane preparation method in which pores are formed using existing inorganic particles.

### TECHNICAL FIELD

The present invention relates to a polyvinylidene difluoride hollow fiber membrane and a method of preparing the same, and more particularly, to an improved polyvinylidene difluoride hollow fiber membrane and a preparing method thereof, in which a spinning solution consisting of polyvinylidene fluoride, alcohol dendrimer and organic solvent is prepared, and then is subjected to solidification by a wet-phase transition process, cleaning and drying, in which alcohol dendrimer that is an organic material as a pore former is introduced, such that alcohol dendrimer is uniformly dispersed in polyvinylidene difluoride to form pores, each having a high dispersion ability and a uniform size, and in which an excellent adhesion durability is imparted owing to the use of a single material of polyvinylidene difluoride, unlike the conventional hollow fiber membrane preparing method in which pores are formed using existing inorganic particles.

### BACKGROUND ART

In general, a separation membrane can be classified into a reverse osmosis (RO) membrane, an ultrafiltration (UF) membrane and a microfiltration (MF) membrane in terms of membrane separation performance, and can be largely classified into a plate-type membrane and a hollow fiber-type membrane in terms of separation membrane module type.

The present invention falls within a microfiltration membrane in terms of separation performance and a hollow fiber type in terms of separation membrane module type, respectively, and is used for eliminating granular materials generated during water purification, waste-water treatment, water preparation in the field of pharmacy and food industry.

Typically, in case of eliminating granular materials, the separation membrane enables the more complete treatment of a to-be-separated material since it has a uniform porous structure that is adjusted very precisely in comparison to a sand filtration method which is most widely used for water purification.

Particularly, the hollow fiber-type membrane has an advantage of a greater treatment capacity at the same site as it requires a relatively small installation area, compared to the plate-type membrane. Owing to the advantage of such a separation membrane, the number of cases, where the separation membrane is applied to a variety of industrial fields, is sharply increasing, recently. In particular, the separation membrane is advantageous in that protozoa, which cannot be removed by means of sand filtration and chlorination, such as cryptosporidium parvum, giardia lamblia, etc., can be effectively removed in case of water purification, hence producing safe drinking water, and it is thus expected to be applied to various industrial fields.

Despite such advantage, a membrane fouling phenomenon should be taken into consideration, where a to-be-separated material is accumulated on the surface of a separation membrane during the use of the separation membrane. Thus, there may be a remarkable difference in the performance of the membrane, depending on how the membrane fouling is eliminated effectively.

A typical example of a method to eliminate the membrane fouling includes a method in which a membrane is cleaned using acid or alkali, particularly chlorine, after using the membrane during a predetermined period of time along with a periodic execution of a back washing process where the treatment water is forcibly pushed through in the opposite direction to that of the water treatment direction, so as to detach fouling materials accumulated on the membrane, or an air cleaning process, where air having low specific gravity is blown into the appropriate position, so as to induce the vibration of the membrane while ascending air bubbles to eliminate the fouling materials.

Such a membrane fouling eliminating method may give damage to a separation membrane, and hence has a direct influence over the lifespan of the separation membrane.

The mechanical properties of the separation membrane, such as tensile strength, elongation (or ductility), chemical resistance, etc., become important factors that determine how the membrane endures the cleaning process, which resultantly decides the usable period of the separation membrane.

The principle of forming pores in the separation membrane basically employs a phase separation.

That is, if more than two materials, well mixed with one another under certain environmental condition, are placed in an environment in which they do not mix with one another, they start to be separated into more than two phases. Then, when the separated phases are immobilized and then specific phase or material is extracted from the separated phases, a pore is formed at the space where the phase or material was extracted from. Of course, even in case where only one component is extracted in a state where the materials are mixed with one another, a pore can be formed. But at this time, since the size of the pore is very small, it is impossible to prepare a separation membrane having the size of a microfiltration membrane.

Meanwhile, an example of an environmental change means for inducing the phase separation may include a method, where a solution containing a dissolved material is mixed with a solvent having a low solubility or no solubility at certain ratio to obtain a mixture, where a process temperature is altered or where the mixture contacts moisture in the air.

The most common separation membrane preparing method includes the following steps: dissolving a membrane-forming polymer in a solvent having a high solubility to produce a solution; blending the produced solution with another solvent having a low solubility or no solubility to the polymer in certain proportions to obtain a blend; permitting the blend to contact moisture in the air to make a phase separation up to a predetermined level to obtain separated phases; and immobilizing the separated phases in a coagulation bath containing the other solvent having no solubility to the polymer, especially water and eluting a hydrophilic additive, etc., to thereby produce a separation membrane having pores of desired sizes formed therein.

Another method of forming pores in the separation membrane has also been proposed, in which a polymer is dissolved in a solvent having solubility thereto at a predetermined temperature to induce a phase separation at a low temperature, and then the separated phases are immobilized in a coagulation bath and specific components are extracted from the separated phases to thereby form pores in the membrane.

Furthermore, a separation membrane preparing method has also been proposed, in which inorganic particles separated into phases of a certain size are dispersed in a fused polymer to form a heterogeneous mixture, immobilized at a low temperature, and then only the inorganic particle is removed from the solid mixture to thereby prepare a separation membrane having pores of desired sizes formed therein.

Meanwhile, up to now, various materials have been used for the preparation of the separation membrane, but a separation membrane, which is prepared by using polyvinylidene difluoride (PVDF) having a relatively strong resistance against acid, alkali, particularly chloride, etc., as compared to other materials such as, for example, cellulose, polyacrylonitrile (PAN), polyethylene and polysulfone, is being proposed.

For example, U.S. Pat. No. 5,472,607 to Mailvaganam et al discloses a hollow fiber semipermeable membrane of a tubular braid, which is produced by coating a solution having polyvinylidene difluoride dissolved therein on a knitted fabric, made of polyester or polyamide fiber. The aforementioned PCT International Patent Publication No. WO 02/070115 discloses a method of preparing a hollow fiber, in which after polyvinylidene difluoride and inorganic particles have been mixed and melt to obtain a melt solution, the melt solution is extruded through a spinneret with orifices and then the extracted filaments are cooled to form a hollow fiber shape, followed by the extraction of the inorganic particles through an extraction process to thereby prepare a hollow fiber having pores formed therein.

Specifically, a hollow fiber membrane preparing method of the '607 patent entails several shortcomings that it employs a knitted fabric so as to be able to obtain very excellent mechanical and physical properties (tensile strength or ductility), but two essentially different materials, that is, the separation membrane and the knitted fabric become weak in adhesion therebetween such that they tend to be separated according to the environments of usage, making it impossible to obtain the desired water quality for treatment, and that a thin film membrane cannot be produced due to the thickness of the knitted fabric, resulting in a relatively decreased area of the membrane.

The hollow fiber membrane preparing method of the aforementioned WO 02/070115 International patent entails the following shortcomings: since a hollow fiber membrane is prepared by melting polyvinylidene difluoride at a higher temperature than a melting point of polyvinylidene difluoride, a relatively large amount of energy is consumed, compared to the forming method of a polymer solution using a commonly known organic solvent. Also since a finished hollow fiber having pores formed therein is prepared after a hollow fiber shape has been formed by blending polyvinylidene difluoride and the inorganic particles of certain sizes, it typically has a large surface area. Furthermore, since the hollow fiber is greatly influenced by the energy from the interfaces between the polymer and the inorganic particles, the inorganic particles are not well dispersed in the polymer due to difficult-to-disperse sub-micron sizes thereof, resulting in a lack of uniformity in size of pores. Furthermore, a general asymmetric porous structure cannot be produced, in which pores are densely formed on a separable surface layer of the hollow fiber and relatively large-sized pores are formed inside the hollow fiber to cause a small energy loss according to the movement of fluid. Such an asymmetric porous structure has advantage of its excellence, in terms of a membrane fouling elimination effect using back washing or air bubble formation than a symmetric porous structure.

### DISCLOSURE OF INVENTION

### Technical Problem

Accordingly, the inventors of the present invention have continuously conducted researches to address and solve the aforementioned problems occurring in the prior art, and as a result, have completed the present invention by dissolving polyvinylidene difluoride and alcohol dendrimer serving as a pore former in a solution with a solubility of more than certain level to form a spinning solution, then subjecting the spinning solution to a wet-phase transition using a mixed solvent, in order to make a uniform phase separation.

According to the present invention, it is possible to solve all the shortcomings of the prior art such as increased consumption of energy, desorption of the membrane and the failure in implementation of the asymmetric porous structure. Moreover, the polyvinylidene difluoride hollow fiber membrane according to the present invention has a very elaborate asymmetric porous structure and enables the preparation of a hollow fiber type microfiltration membrane, made of a single material of polyvinylidene difluoride with high chemical resistance.

Furthermore, in the present invention, a preparation method of a hollow fiber membrane made of a single material of polyvinylidene difluoride using alcohol dendrimer, wherein the hollow fiber membrane includes an asymmetric porous structure, in which the pore having a diameter ranging from 0.01 to 0.4 μm is formed on the outer surface layer of the hollow fiber membrane while the pore having a diameter ranging from 0.5 to 10 μm is formed in the inner surface layer of the hollow fiber membrane, and of which does not have a fiber support formed therein, is proposed.

Accordingly, it is the object of the present invention to provide a composition for a polyvinylidene difluoride hollow fiber membrane, a polyvinylidene difluoride hollow fiber membrane and a method of preparing the polyvinylidene difluoride hollow fiber membrane.

### Technical Solution

To accomplish the above object, according to one aspect of the present invention, a composition for a polyvinylidene difluoride hollow fiber membrane, which comprises 10 to 50% by weight of polyvinylidene difluoride, 0.05 to 15% by weight of alcohol dendrimer as a pore former represented by the following Formula 1 or 2, and 20 to 90% by weight of an organic solvent, based on the total weight of the composition, is provided:

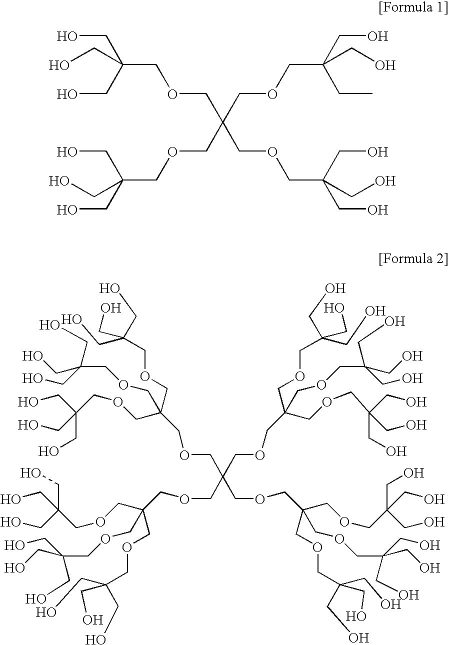

According to another aspect of the present invention, a preparation method of a polyvinylidene difluoride hollow fiber membrane is provided, and the method comprises the steps of: (a) preparing a spinning solution containing 10 to 50% by weight of polyvinylidene difluoride, 0.05 to 15% by weight of alcohol dendrimer represented by the following Formula 1 or 2, and 20 to 90% by weight of an organic solvent, based on the total weight of the solution; (b) solidifying the spinning solution prepared in the step (a) through a wet-phase transition process to yield a polyvinylidene difluoride hollow fiber membrane; and (c) washing and drying of the polyvinylidene difluoride hollow fiber membrane yielded in the step (b):

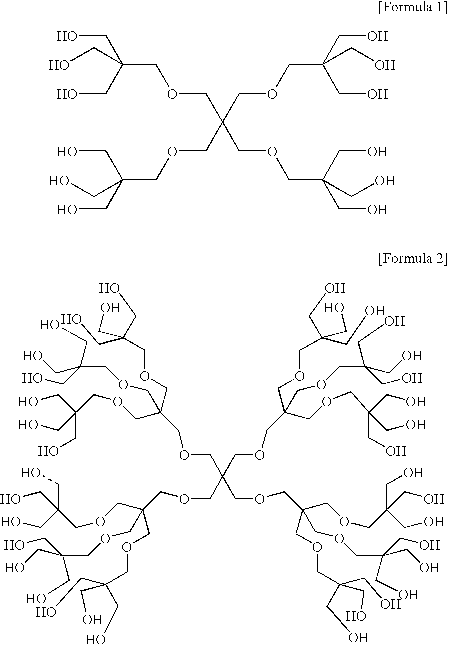

According to another aspect of the present invention, there is also provided a polyvinylidene difluoride hollow fiber membrane prepared by the above method, where the hollow fiber membrane includes an asymmetric porous structure, in which the pore formed on the outer surface layer of the hollow fiber membrane has a diameter ranging from 0.01 to 0.4 μm while the pore formed in the inner surface layer of the hollow fiber membrane has a diameter ranging from 0.5 to 10 μm, with the hollow fiber membrane having an inner diameter in a range of 0.005 to 3.9 mm and an outer diameter in a range of 0.1 to 4 mm, a fracture strength in a range of 5.0 to 15.0 MPa, a fracture elongation in a range of 30 to 120%, and a pure water transmissivity in a range of 400 to 1200 LMH.

### Advantageous Effects

As described above, according to the present invention, a polyvinylidene difluoride hollow fiber membrane, excellent in terms of mechanical properties and chemical resistance, is prepared for a separation membrane made of a single material, dissimilarly to a conventionally known technique, in order prevent the problem which may occur as the deterioration in adhesion durability according to the use of one or more materials. Furthermore, alcohol dendrimer, which is an organic material as a pore former, is used to enable the preparation of a a polyvinylidene difluoride hollow fiber membrane with uniformly sized pores, due to its excellent dispersibility with respect to polyvinylidene difluoride, unlike the conventional hollow fiber membrane preparation method, in which pores are formed using existing inorganic particles.

In addition, the inventive polyvinylidene difluoride hollow fiber membrane has an asymmetric porous structure, in which the diameter of a pore formed on the outer surface layer thereof, is different from that of a pore formed in the inner surface layer thereof, and is effective for the control of the membrane fouling, owing to an increase in mechanical and physical properties thereof.

### DESCRIPTION OF DRAWINGS

FIG. 1(a) to 1(c) are scanning electron microscope (SEM) photographs illustrating an outer surface, an inner surface and a cross section of a polyvinylidene difluoride hollow fiber membrane, produced by Example 1 of the present invention.

### BEST MODE

The present invention is directed to an improved polyvinylidene difluoride hollow fiber membrane and a preparation method thereof, in which a spinning solution consisting of polyvinylidene fluoride, alcohol dendrimer and organic solvent is prepared, and then is subjected to solidification by a wet-phase transition process, cleaning and drying, in which alcohol dendrimer that is an organic material as a pore former is introduced such that alcohol dendrimer is uniformly dispersed in polyvinylidene difluoride to form pores, each having a high dispersion ability and a uniform size, and in which an excellent adhesion durability is imparted, owing to the use of a single material of polyvinylidene difluoride, unlike the conventional hollow fiber membrane preparation method, in which pores are formed using existing inorganic particles.

Now, the preparation method of a polyvinylidene difluoride hollow fiber membrane will be described in more detail hereinafter:

The first step of the above hollow fiber membrane preparing method is a step of preparing a spinning solution containing 10 to 50% by weight of polyvinylidene difluoride, 0.05 to 15% by weight of alcohol dendrimer represented by the above Formula 1 or 2, and 20 to 90% by weight of an organic solvent, based on the total weight of the solution;

The present invention employs polyvinylidene difluoride alone as an ingredient, to constitute a composition for preparing the polyvinylidene difluoride hollow fiber membrane, and dendrimer as a pore former for forming pores in the hollow fiber membrane. In this case, dendrimer has a shape, in which numerous branches spread from a core. In particular, the dendrimer means alcohol dendrimer having alcohol group bonded to dendrimer and employs dendrimer represented by Formula 1 or 2. Such a dendrimer is advantageous as its shape is regular and its size is uniform, hence enabling the size of a pore to be adjusted uniformly.

The polyvinylidene difluoride has a molecular weight in the range of 50,000 to 800,000 daltons, preferably in the range of 50,000 to 600,000 daltons. At this time, if the molecular weight of the polyvinylidene difluoride is less than 50,000 daltons, the mechanical and physical properties of the hollow fiber membrane is deteriorated, and if it exceeds 800,000 daltons, the polyvinylidene difluoride is difficult to dissolve and is high in viscosity, which requires a high temperature above 200° C. upon the spinning process to form a hollow fiber.

The polyvinylidene difluoride is used in an amount of 2 to 50% by weight, preferably of 10 to 50% by weight based on the total weight of the spinning solution containing polyvinylidene difluoride. If the content of polyvinylidene difluoride is used in an amount of less than 10% by weight, based on the total weight of the spinning solution, the viscosity of the spinning solution becomes very low, which makes it impossible to obtain a hollow fiber shape. Also, if the content of polyvinylidene difluoride is used in an amount of more than 50% by weight based on the total weight of the spinning solution, the viscosity of the spinning solution becomes very high, which makes it impossible to yield a hollow fiber membrane of desired mechanical and physical properties, due to thermal decomposition despite an increase in the spinning temperature.

A pore former of the present invention employs alcohol dendrimer represented by the above Formula 1 or 2. The alcohol dendrimer is used in an amount of 0.01 to 15% by weight, preferably of 0.05 to 15% by weight, based on the total weight of the spinning solution containing alcohol dendrimer. If the content of alcohol dendrimer is used in an amount of less than 0.1% by weight based on the total weight of the spinning solution, the size of a pore becomes very small, which is not suitable for the use in a microfiltration membrane or an ultrafiltration membrane. Also, if the content of alcohol dendrimer is used in an amount of more than 15% by weight based on the total weight of the spinning solution, a phase separation of the spinning solution is progressed, such that a hollow fiber is not formed through the spinning process.

The organic solvent is either one selected from the group consisting of dimethylformaldehyde, dimethylaceteamide, N-methylpyrolidone, γ-Butyrolactone, dimethylsulfoxide, triethylphostate and acetone, or a mixture of two or more thereof. The organic solvent is used in an amount of 10 to 90% by weight, preferably of 20 to 90% by weight, based on the total weight of the spinning solution containing the organic solvent. In this case, if the content of organic solvent is used in an amount of less than 20% by weight based on the total weight of the spinning solution, the viscosity of the spinning solution becomes high, which requires a high temperature of above 200° C. upon the spinning process to form a hollow fiber. Also, if the content of organic solvent is used in an amount of more than 90% by weight based on the total weight of the spinning solution, the viscosity of the spinning solution becomes low, which leads to a degradation in mechanical and physical properties of the hollow fiber membrane. The spinning solution is dissolved at a temperature ranging from 25 to 200° C., preferably between 25 and 180° C. If the temperature required to dissolve the spinning solution is set to be lower than 25° C., it takes a long time to prepare the spinning solution. Also if the temperature is set to be higher than 200° C., an additive such as dendrimer, etc., is decomposed, so that a desired hollow fiber membrane cannot be obtained.

The second step of the above hollow fiber membrane preparation method is a step of solidifying the spinning solution prepared in the first step through a wet-phase transition process to yield a polyvinylidene difluoride hollow fiber membrane.

The spinning solution prepared in the first step is spun through a spinneret composed of double tubes into a coagulation bath to form a hollow fiber membrane shape. At this time, it is possible to selectively set an outer diameter of a slit constituting the spinneret to be within a range between 0.3 and 8.0 mm, an inner diameter of the slit to be within a range between 0.2 and 7.0 mm, and an inner diameter of an injection tube to be within a range between 0.1 and 3.5 mm, depending on the size of a desired hollow fiber membrane.

At this time, the temperature of the spinneret is related to the composition of the spinning solution. Herein, the spinning process is carried out in such a fashion that the spinning solution is spun (discharged) through the spinneret maintained at a temperature ranging from 0 to 200° C., preferably between 0 and 200° C., into a coagulation bath to thereby yield a desired polyvinylidene difluoride hollow fiber membrane. In this case, if the temperature of the spinneret is set to be lower than 0° C., the viscosity of the spinning solution becomes high, such that a high pressure is required to spin the spinning solution and deformation is increased to disperse an internal stress after spinning, which makes it difficult to obtain a hollow fiber membrane of a desired dimension. Furthermore, if the temperature of the spinneret is set to be higher than 200° C., the decomposition of dendrimer occurs, which makes it impossible to yield a desired hollow fiber.

The wet-phase transition process is performed in a coagulation bath maintained at a temperature ranging from 0 to 200° C., preferably between 0 and 180° C. In this case, if the internal temperature of the coagulation bath is set to be lower than 0° C. Or higher than 200° C., it is difficult to yield a hollow fiber having a desired dimension and pore size.

The wet-phase transition process is performed by using water or a mixed solvent of two or more selected from water and the organic solvent used upon the preparation of the spinning solution, the water or the mixed solvent being the liquid for forming a hollow part of the hollow fiber membrane, as an internal coagulant, and using water or a mixed solvent of two or more selected from water, the organic solvent used upon the preparation of the spinning solution and polyhydroxy alcohol as external coagulant.

At this time, the organic solvent is used in an amount of 1 to 100% by weight, preferably of 5 to 100% by weight, based on the total weight of the mixed solvent. If the content of the organic solvent is used in an amount of less than 1% by weight based on the total weight of the mixed solvent, pores are not formed on the inner circumferential surface of the hollow fiber membrane. The polyhydroxy alcohol uses any one selected from the group consisting of polyethyleneglycol, glycerine, diethyleneglycol and triethyleneglycol.

In the meantime, the spinning solution spun through the spinneret is solidified in a coagulation bath. At this time, the distance from the spinneret to the coagulation bath is called the ‘air gap’, of whose length is in the range between 0 and 200 cm, preferably between 0 and 180 cm. That is, if the air gap exceeds 200 cm, the phase separation is excessively progressed, such that it is difficult to form a hollow fiber membrane.

The coagulation bath may employ a single bath or a multi-staged bath, in which several baths are connected to one another. The coagulation bath uses any one selected from or a mixed solvent of two or more selected from water, the organic solvent used upon the preparation of the spinning solution and polyhydroxy alcohol. At this time, the temperature of the mixed solvent is kept in the range between 0 and 200° C., preferably between 0 and 180° C. If the temperature of the mixed solvent is in a range of lower than 0° C. or higher than 200° C., it is impossible to yield a hollow fiber membrane having a desired pore size or maintain a hollow fiber shape.

The third step of the above hollow fiber membrane preparing method is a step of washing and drying the polyvinylidene difluoride hollow fiber membrane yielded in the second step.

The hollow fiber membrane is washed using pure water from which ion components are removed, and is dried at 150° C. or lower. At this time, if the drying temperature exceeds 150° C., the pore size becomes small or the hollow fiber membrane is deformed.

The inventive polyvinylidene difluoride hollow fiber membrane prepared in the aforementioned manner includes an asymmetric porous structure, in which a pore formed on the outer surface layer of the hollow fiber membrane has a diameter ranging between 0.01 and 0.4 μm while a pore formed in the inner surface layer of the hollow fiber membrane has a diameter ranging between 0.5 and 10 μm, the hollow fiber membrane having an inner diameter in the range of 0.005 to 3.9 mm, preferably of 0.2 to 2.0 mm, an outer diameter in the range of 0.1 to 4 mm, preferably of 0.1 to 4 mm, a fracture strength in the range of 5.0 to 15.0 MPa, a fracture elongation in the range of 30 to 120%, and a pure water transmissivity in the range of 400 to 1200 LMH. Also the hollow fiber membrane prepared according to the present invention does not have a fiber support formed therein, and consists of a single polyvinylidene difluoride component.

In this case, the hollow fiber membrane with an outer diameter of 4 mm or more is also called a tubular membrane, but not a hollow fiber membrane. Such a tubular membrane, which is used for concentration of juice solution having a high viscosity, may underline a disadvantage of a decrease in the inner surface area of the hollow fiber membrane, rather than an advantage in view of a to-be-separated material having a low viscosity, such as an object of water treatment to be mainly intended in the present invention. In addition, if the inner diameter of the hollow fiber membrane is 0.05 mm or less, a difference between the inner diameter and the outer diameter of the hollow fiber membrane, namely, the thickness of the hollow fiber membrane becomes too large, and hence a trans-membrane pressure, i.e., a pressure applied between the inner and outer membrane layers is increased. If the length of the hollow fiber membrane is made large, the pressure loss also becomes large, leading to an increase in the power cost. On the other hand, if the thickness of the hollow fiber membrane is made small, a very thin hollow fiber is formed in its entirety and the inner surface area of the hollow fiber membrane is thus increased. Nevertheless, as aforementioned, if the length of the hollow fiber membrane is made large, a shortcoming still remains that the pressure loss also becomes large and another demerit is caused that the mechanical and physical properties of the membrane is weakened, which makes it impossible to use the hollow fiber membrane for a long period of time.

### MODE FOR INVENTION

The present invention will hereinafter be described in further detail through examples. It will however be obvious to a person skilled in the art that these examples can be modified into various different forms and the present invention is not limited to or by the examples. These examples are presented to further illustrate the present invention.

### REFERENCE EXAMPLE

### Preparation of Alcohol Dendrimer

Alcohol dendrimer used in the following Examples and Comparative Examples 1 to 4 was prepared through the following method: 13.6 g of pentaerythritol and 16.22 g of triethylorthoacetate were put into a solution prepared by dissolving 0.5 g of pyridinium paratoluene sulfonate in 100 mL of diocthylphthalate and slowly heated to a temperature of 130 to 140° C. to distil ethanol. After ethanol, the amount of which corresponds to a theoretical amount, has been extracted, MBO was distilled and recovered, which has a structure in which three of four hydroxyl groups of pentaerythritol were blocked as illustrated in Chemical Reaction Formula 1 under a vacuum of 0.1 torr.

Immediately following the preparation of 6.4 g of MBO as above, it was charged slowly into 200 mL of DMSO having 36.2 g of KOH dispersed therein, and 15.5 g of pentaerythritol tetrabromide (DEBr4, Aldrich) was added to the reaction solution and stirred vigorously for 5 hours to obtain a mixture. Thereafter, the mixture was diluted in 500 mL of water and extracted using diethylether to thereby obtain DEMBO4 having a structure, in which four Br atoms of PhBr4 are substituted into MBO.

After 23.4 g of DEMBO4 was dissolved in 250 mL of methanol to prepare a solution, 400 mL of 0.01 N hydrochloric acid was charged into the solution and stirred for 2 hours, followed by distillation. As a result, a solution of a high viscosity having water and methanol removed therefrom was recrystallized in a mixed solution of methanol and diethylether (volumetric ratio is 3:1) to thereby obtain DEOH12 having a structure, in which the blocking of the three hydroxyl groups in MBO is released as represented by Reaction Formula 1. The obtained DEOH12 was repeatedly subjected to the above process to obtain DEOH36 [see Reaction Formula].

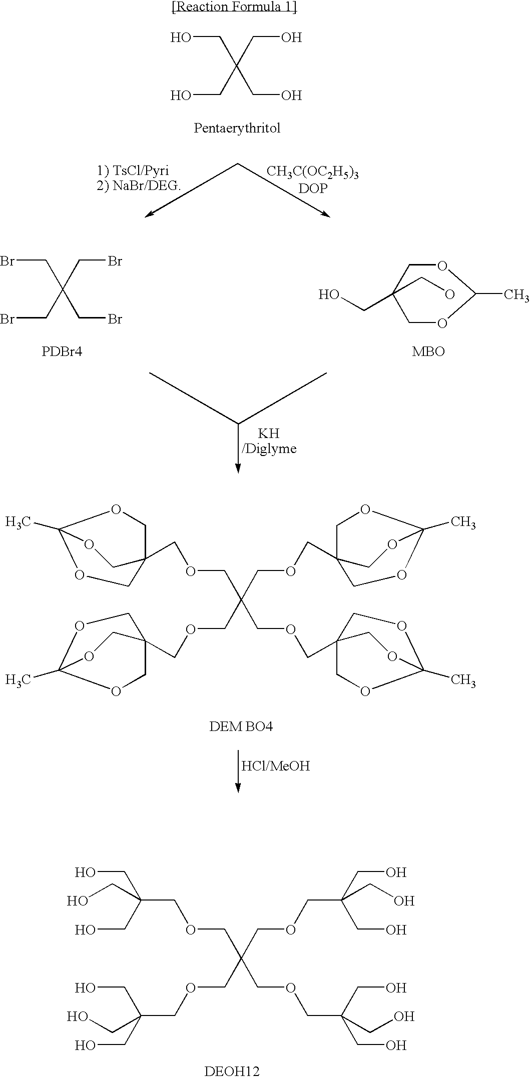

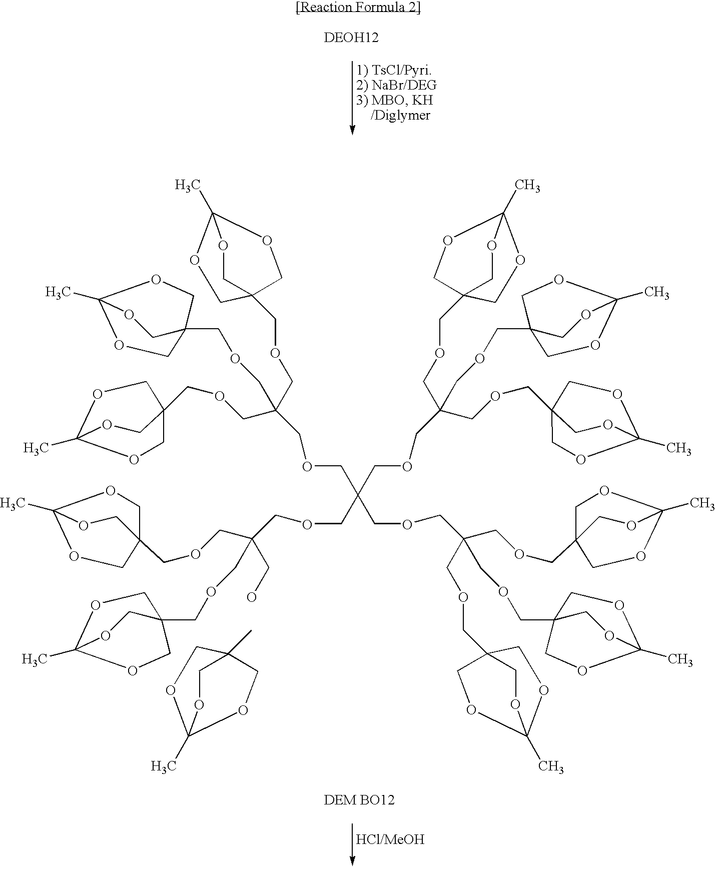

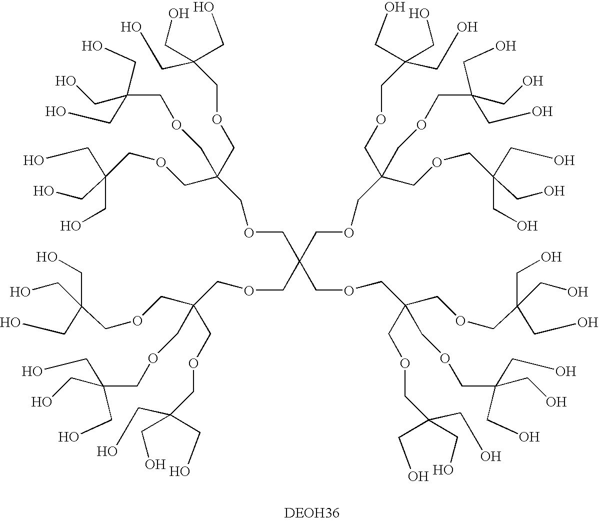

### Example 1

### Preparation of a Polyvinylidene Difluoride Hollow Fiber Membrane

35% by weight of polyvinylidene difluoride (PVDF, HYLAR-461), 60% by weight of N-methylpyrolidobne, and 5% by weight of DEOH12 were mixed with each another and stirred at 100° C. for 5 hours to prepare a spinning solution. Then, the spinning solution was left to stand at 100° C. for about 2 hours to eliminate air bubbles therefrom.

The prepared spinning solution was spun through a spinneret (having an outer diameter of a slit in a range of 3.5 mm, an inner diameter of the slit in a range of 1.6 mm, and an inner diameter of an injection tube thereof in a range of 0.5 mm) composed of double tubes into a coagulation bath for solidification of the spun solution to thereby form a hollow fiber membrane shape. At this time, for the purpose of formation of a hollow part in the hollow fiber membrane, a solution prepared by mixing 20% by weight of NMP and 80% by weight of water was spun through the slit of the spinneret into the coagulation bath at 100° C. while maintaining an air gap of 1 cm.

The first stage of the coagulation bath contained a mixture of 5% by weight of NMP and 95% by weight of water and was kept at 0° C. The second stage of the coagulation bath contained water and was kept at 50° C. And the final third stage thereof contained a mixture 20% by weight of water and 80% by weight of ethanol and was kept at 25° C.

The hollow fiber membrane formed through solidification of the spun solution in the coagulation bath was wound and washed with pure water, and then treated with glycerin. Thereafter, the glycerin treated hollow fiber membrane was dried for 3 days to thereby obtain the inventive polyvinylidene difluoride hollow fiber membrane.

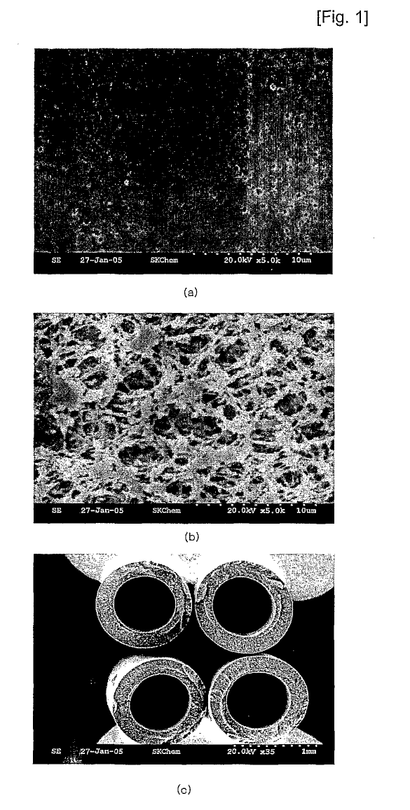

The scanning electron microscope photographs of the outer surface, the inner surface and the across section of the polyvinylidene difluoride hollow fiber membrane obtained by Example 1 were illustrated in FIG. 1.

### Example 2

### Preparation of a Polyvinylidene Difluoride Hollow Fiber Membrane

The polyvinylidene difluoride hollow fiber membrane was prepared in the same manner as that described hereinabove in Example 1, except DEOH36 being used as a pore former in the composition as shown in Table 1 below.

### Comparative Examples 1 to 4

### Preparation of a Polyvinylidene Difluoride Hollow Fiber Membrane

The polyvinylidene difluoride hollow fiber membrane was prepared in the same manner as that described hereinabove in Example 1, except the spinning solution being used in the composition ratio as shown in Table 1 below.

TABLE 1

| | | Organic solvent | Alcohol denrimer |
|---|---|---|---|
| | PVDF (wt %) | (wt %) | (wt %) |
| Ex. 2 | 35 | NMP: 60.0 | DEOH36: 5 |
| Comp. Ex. 1 | 7.0 | NMP: 88.0 | DEOH12: 5 |
| Comp. Ex. 2 | 50.1 | NMP: 44.9 | DEOH12: 5 |
| Comp. Ex. 3 | 35 | NMP: 64.07 | DEOH12: 0.03 |
| Comp. Ex. 4 | 35 | NMP: 45 | DEOH36: 20 |

### Test Example

### Comparison of Physical Properties

The physical properties of the hollow fiber membrane prepared by Examples 1 and 2, and Comparative Examples 1 to 4 were measured in the following manner, and the measurement results are shown in Table 3 below.

### 1. 1) Measurement of Pure Water Transmissivity

The measurement of pure water transmissivity was performed by using a small-sized module formed by folding each of 10 strands of hollow fiber membrane having a length of 50 cm to half of its length, under a pressure of 1.0 kgf/cm² at 25° C., using 18 MΩ of ultra pure water, and treating one end of each strand with polyurethane.

### 2) Measurement of Fracture Strength And Fracture Elongation

The fracture strength and the fracture elongation were measured by exerting a load of 2000 g to a hollow fiber membrane 30 cm in length, at a speed of 50 mm/min.

### 3) Measurement of Inner Diameter And Outer Diameter

The pore size of the inner and outer surfaces of the hollow fiber membrane was measured through a scanning electron microscope, in which case, the pose size of the outer surface of the hollow fiber membrane was measured by a bubble point method using CFP-12000A manufactured by Porous Materials, Inc.

TABLE 2

| | | | | size | | | |
|---|---|---|---|---|---|---|---|
| | Physical properties | | | Hollow fiber membrane | | pore | |
| | Frac. | Frac. | Pure water | Outer | Inner | Inner | Outer |
| | Strength | Elongation | transmissivity | diameter | diameter | surface | surface |
| | (MPa) | (%) | (LMH) | (mm) | (mm) | (μm) | (μm) |
| Ex. 1 | 15.0 | 120 | 410 | 1.7 | 0.8 | 1.5 | 0.12 |
| Ex. 2 | 12.9 | 87 | 1200 | 1.7 | 0.9 | 1.6 | 0.11 |
| Comp. Ex. 1 | 1.3 | 35 | 1240 | 1.7 | 0.9 | 3.1 | 0.45 |
| Comp. Ex. 2 | 20.3 | 83 | 30 | 1.7 | 0.8 | 0.3 | 0.08 |
| Comp. Ex. 3 | 18.0 | 88 | 45 | 1.7 | 0.8 | 0.9 | 0.06 |
| Comp. Ex. 4 | 1.2 | 17 | 750 | 1.7 | 0.9 | 1.8 | 0.24 |

As shown in Table 2 above, in case where the content of alcohol dendrimer (DEOH12 and DEOH36) is used in an amount of 0.1 to 5.0% by weight of based on the total weight of the spinning solution, it was possible to obtain the hollow fiber membrane having a standard dimension, in which its outer diameter is 1.7 mm and its inner diameter is in a range from 0.8 to 0.9 mm, and exhibiting physical properties of a fracture strength of 15.0 MPa at the maximum, a fracture elongation of 120% at the maximum and a pure water transmissivity of 1240 LMH at the maximum. However, it can be seen from Comparative Examples 1 to 4 that, in case where the content of alcohol dendrimer is used in an amount of less than 5.0% by weight of based on the total weight of the spinning solution, the pure water transmissivity of the hollow fiber membrane appears to be very low, but in case where the content of alcohol dendrimer is used in an amount of more than 15.0% by weight of based on the total weight of the spinning solution, the fracture strength and the fracture elongation appear to be very low.

Furthermore, if the content of polyvinylidene difluoride is used in an amount of less than 10% by weight based on the total weight of the spinning solution, the fracture strength of the hollow fiber membrane appears to be very low, but if the content of polyvinylidene difluoride is used in an amount of more than 50% by weight based on the total weight of the spinning solution, the pure water transmissivity of the hollow fiber membrane is very low, which does not appear to be effective as a hollow fiber membrane.

### INDUSTRIAL APPLICABILITY

As described above, according to the present invention, a polyvinylidene difluoride hollow fiber membrane, excellent in terms of mechanical properties and chemical resistance is prepared for a separation membrane made of a single material, dissimilarly to a conventionally known technique, such that a problem can be prevented that there may occur a deterioration in adhesion durability, according to the use of one or more materials. Furthermore, alcohol dendrimer, that is an organic material as a pore former, is used such that a polyvinylidene difluoride hollow fiber membrane with uniformly sized pores can be prepared due to its excellent dispersibility with respect to polyvinylidene difluoride, unlike a conventional hollow fiber membrane preparing method, in which pores are formed using existing inorganic particles.

In addition, the inventive polyvinylidene difluoride hollow fiber membrane has an asymmetric porous structure, in which the diameter of a pore formed on the outer surface layer thereof is different from that of a pore formed in the inner surface layer thereof, and is effective for the control of the membrane fouling owing to an increase in mechanical and physical properties thereof.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A composition for a polyvinylidene difluoride hollow fiber membrane, which comprises 10 to 50% by weight of polyvinylidene difluoride, 0.05 to 15% by weight of alcohol dendrimer represented by the following Formula 1 or 2, and 20 to 90% by weight of an organic solvent, based on the total weight of the composition:

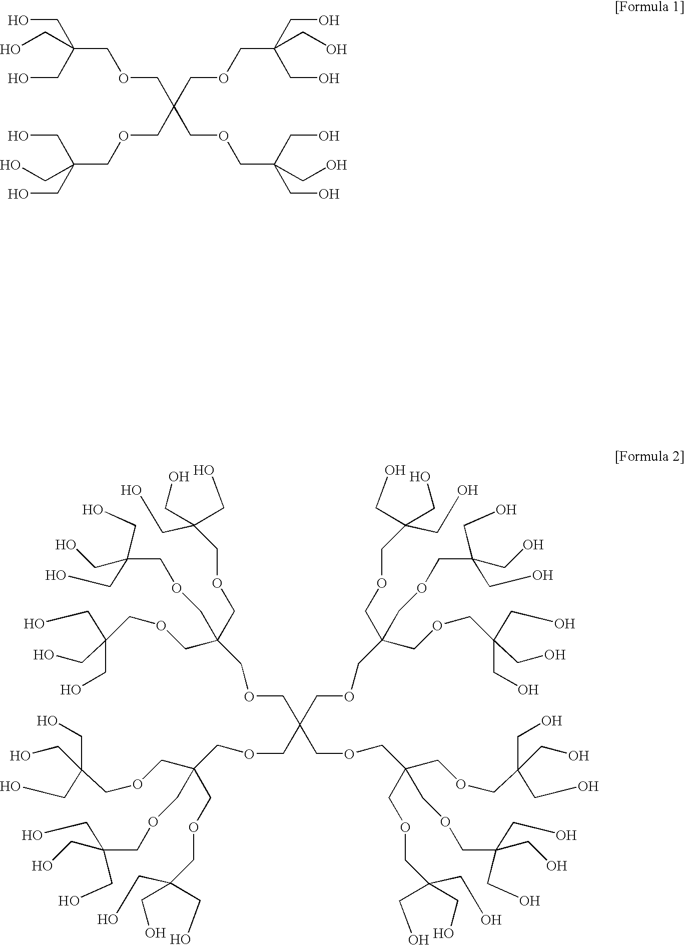

2. The composition as defined in claim 1, wherein the polyvinylidene difluoride has a molecular weight in a range of 50,000 to 800,000 daltons.

3. The composition as defined in claim 1, wherein the organic solvent is either one selected from the group consisting of dimethylformaldehyde, dimethylaceteamide, N-methylpyrolidone, γ-Butyrolactone, dimethylsulfoxide, triethylphostate and acetone, or a mixture of two or more thereof.

4. A preparation method of a polyvinylidene difluoride hollow fiber membrane, the method comprises the steps of:
(a) preparing a spinning solution containing 10 to 50% by weight of polyvinylidene difluoride, 0.05 to 15% by weight of alcohol dendrimer represented by the following Formula 1 or 2, and 20 to 90% by weight of an organic solvent, based on the total weight of the solution;
(b) solidifying the spinning solution prepared in the step (a) through a wet-phase transition process to yield the polyvinylidene difluoride hollow fiber membrane; and
(c) washing and drying the polyvinylidene difluoride hollow fiber membrane yielded in the step (b):

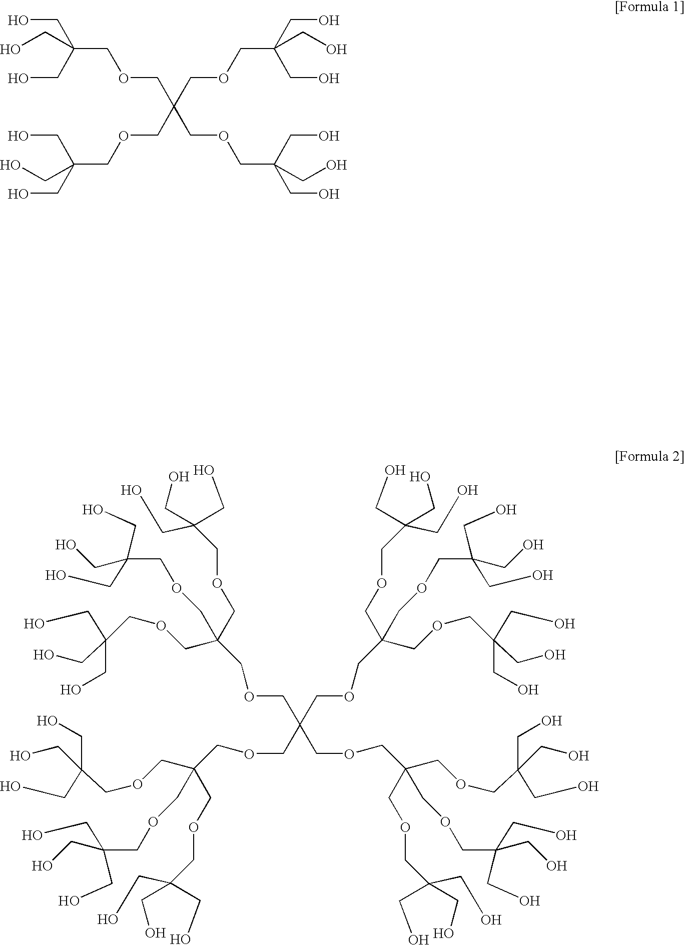

5. The method as defined in claim 4, wherein the wet-phase transition process is performed under a temperature condition maintained in a range from 0 to 200□

6. The method as defined in claim 4, wherein the wet-phase transition process is performed by using water or a mixed solvent of two or more selected from water and the organic solvent as an internal coagulant, and using water or a mixed solvent of two or more selected from water, the organic solvent and polyhydroxy alcohol as external coagulant.

7. The method as defined in claim 6, wherein the polyhydroxy alcohol is any one selected from the group consisting of polyethyleneglycol, glycerine, diethyleneglycol and triethyleneglycol.

8. A polyvinylidene difluoride hollow fiber membrane prepared by the method as defined in claim 4, where the hollow fiber membrane includes an asymmetric porous structure, in which a pore formed on the outer surface layer of the hollow fiber membrane has a diameter ranging between 0.01 and 0.4 μm while a pore formed in the inner surface layer of the hollow fiber membrane has a diameter ranging between 0.5 and 10 μm, the hollow fiber membrane having an inner diameter in a range of 0.005 to 3.9 mm, an outer diameter in a range of 0.1 to 4 mm, a fracture strength in a range of 5.0 to 15.0 MPa, a fracture elongation in a range of 30 to 120%, and a pure water transmissivity in a range of 400 to 1200 LMH.

9. A polyvinylidene difluoride hollow fiber membrane prepared by the method as defined in claim 5, where the hollow fiber membrane includes an asymmetric porous structure, in which a pore formed on the outer surface layer of the hollow fiber membrane has a diameter ranging between 0.01 and 0.4 μm while a pore formed in the inner surface layer of the hollow fiber membrane has a diameter ranging between 0.5 and 10 μm, the hollow fiber membrane having an inner diameter in a range of 0.005 to 3.9 mm, an outer diameter in a range of 0.1 to 4 mm, a fracture strength in a range of 5.0 to 15.0 MPa, a fracture elongation in a range of 30 to 120%, and a pure water transmissivity in a range of 400 to 1200 LMH.

10. A polyvinylidene difluoride hollow fiber membrane prepared by the method as defined in claim 6, where the hollow fiber membrane includes an asymmetric porous structure, in which a pore formed on the outer surface layer of the hollow fiber membrane has a diameter ranging between 0.01 and 0.4 μm while a pore formed in the inner surface layer of the hollow fiber membrane has a diameter ranging between 0.5 and 10 μm, the hollow fiber membrane having an inner diameter in a range of 0.005 to 3.9 mm, an outer diameter in a range of 0.1 to 4 mm, a fracture strength in a range of 5.0 to 15.0 MPa, a fracture elongation in a range of 30 to 120%, and a pure water transmissivity in a range of 400 to 1200 LMH.

11. A polyvinylidene difluoride hollow fiber membrane prepared by the method as defined in claim 7, where the hollow fiber membrane includes an asymmetric porous structure, in which a pore formed on the outer surface layer of the hollow fiber membrane has a diameter ranging between 0.01 and 0.4 μm while a pore formed in the inner surface layer of the hollow fiber membrane has a diameter ranging between 0.5 and 10 μm, the hollow fiber membrane having an inner diameter in a range of 0.005 to 3.9 mm, an outer diameter in a range of 0.1 to 4 mm, a fracture strength in a range of 5.0 to 15.0 MPa, a fracture elongation in a range of 30 to 120%, and a pure water transmissivity in a range of 400 to 1200 LMH.
